(19) United States
(12) Patent Application Publication
(10) Pub. No.: US 2021/0181421 A1
(43) Pub. Date: Jun. 17, 2021

(54) Modular Optical Tap Device

(71) Applicant: Cox Communications, Inc., Atlanta, GA (US)

(72) Inventor: Brian Yarbrough, Atlanta, GA (US)

(73) Assignee: Cox Communications, Inc., Atlanta, GA (US)

(21) Appl. No.: 17/119,782

(22) Filed: Dec. 11, 2020

Related U.S. Application Data
(60) Provisional application No. 62/946,872, filed on Dec. 11, 2019.

(51) Int. Cl. G02B 6/28; H04B 10/27; H04B 10/25; H04B 10/67

(52) U.S. Cl. CPC G02B 6/2852; H04B 10/67; H04B 10/25; H04B 10/27

(57) ABSTRACT

A modular optical tap device as described herein may include a coupler comprising an input configured to be connected to an upstream portion of a network and a first output configured to be connected to a downstream portion of the network. The optical tap device may also include a splitter with an input configured to be connected to a second output of the coupler and one or more outputs configured to be connected to one or more customer devices, wherein the coupler and splitter are modular components in the optical tap device and are configured to be replaced with a second coupler and a second splitter based on a number of customer devices associated with the optical tap device.

### BACKGROUND

Certain networks, such as Passive Optical Networking (PON) networks (or any other type of network) may often include active or passive tap devices. These tap devices may be inserted into locations on a network and may be used to split or copy packets from the network for creating additional customer service access points. A tap may also be associated with a split-ratio, which may be indicative of a percentage of signal received by the tap that is passed through the tap and downstream the network versus a percentage of signal that is split off for creating additional network terminations. With respect to these tap devices, conventional networks may use centralized banks of optical splitters in cabinets based on a pre-established static split ratio, which in most cases may require one fiber for each customer spliced in parallel. Fiber drop cables may be connected to the tap legs, run to the customer premise, and connect to termination equipment such as a PON ONT (Optical Network Terminal) and Gateway devices. The tap system may be a controlled approach to managing signal levels to each customer throughout the network while optimizing efficiencies of fiber usage.

Conventional methods may use a static pre-determined split ratio, such as, for example 1:64 because may be the most loss a commercial PON network may be able to withstand before signal degradation. The two primary architecture types used today may include centralized splitters and distributed splitters (examples of which may be depicted in FIGS. 2A and 3A described below). A centralized splitter architecture may be a centralized bank of splitters in a cabinet based on a pre-determined static split ratio (1:64, for example). In this configuration each customer may get their own dedicated fiber spliced in parallel from the cabinet to customer premise. A distributed splitter architecture may also be based on a pre-determined static split ratio (1:64, for example), but a portion of that split ratio may be distributed to a fiber enclosure (for example, cross connect) closer to the customer. For example, it may be common for an operator to distribute a 1×4 splitter near the customer and assume the first 1×16 of the total 1:64 split ratio is in the cabinet. The advantage of distributing splitters over centralized splitters may include the reduction in fiber and splices required to build the network, which may result in cost savings. However, it can be wasteful because with any static split ratio it may be rare to actually have exactly 64 customers to feed, so those additional ports may get stranded. Furthermore, in a static split ratio architecture, the more of the split ratio that is distributed, the more ports that may be stranded, because one common distributed splitter size may be needed to maintain consistent signal loss to each customer.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral may identify the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIGS. 1A-1D depict example schematic illustrations of an optical tap device, in accordance with one or more example embodiments of the disclosure.

FIGS. 2A-2B depict an example comparison of conventional optical tap configurations in a network in a network as described herein, in accordance with one or more example embodiments of the disclosure.

FIGS. 3A-3B depict an example comparison of conventional optical tap configurations in a network in a network as described herein, in accordance with one or more example embodiments of the disclosure.

FIG. 4 depicts a table including example tap value combinations and system map symbology, in accordance with one or more example embodiments of the disclosure.

FIG. 5 depicts an example system of a typical plant map, in accordance with one or more example embodiments of the disclosure.

FIG. 6 depicts an example method, in accordance with one or more example embodiments of the disclosure.

FIG. 7 depicts a schematic illustration of an example network architecture, in accordance with one or more example embodiments of the disclosure.

FIG. 8 depicts a schematic illustration of an example computing device architecture, in accordance with one or more example embodiments of the disclosure.

### DETAILED DESCRIPTION

This disclosure relates to, among other things, distributed optical tap devices, which may be deployed in a network, such as a Passive Optical Networking (PON) network, for example. These optical tap devices may be referred to herein as “optical taps,” “tap devices,” “optical tap devices,” “taps,” or the like. The distributed optical taps described herein may form a modular system of passive field installable devices, which may be integrated with a combination of optical couplers and splitters to efficiently manage port counts and signal levels throughout an optical point-to-multi-point network. An individual optical tap may contain varying types of integrated optical couplers and splitters to create a structured system of loss values to enable operator design control and flexibility while minimizing splicing labor. Conventional networks may centralize banks of optical splitters in cabinets based on a pre-established split ratio, which in most cases require one fiber for each customer spliced in parallel. In contrast, this optical tap system may allow for a single fiber to be spliced in series in-and-out of customer demarcation points to tap off only the minimal amount of signal and ports required to service that location and send remaining signal down the line (for example, to other optical tap devices connected to other customer devices). The optical tap devices may also be modular and may not be pre-installed into an enclosure or terminal, and may be intended to be deployed in multiples into any type of fiber terminals or enclosures. Additionally, the integrated coupler stage and splitter stage of the optical tap may be included within the same package and spliced together internally. The optical tap device may be associated with fixed loss parameter(s) on the tap legs (for example, the outputs of the second stage splitter that are fed to the customer devices) while optimizing throughput downstream to a downstream portion of the network including other optical tap devices. This configuration may improve efficiency to manage optical signal strength throughout PON (G-PON, XG-PON) network and may also minimize splicing labor requirements. This configuration may also allow the optical tap devices to be sized (for example, a number of legs included in the tap) based on the need of the location at which they are being deployed. Conventional methods, in contrast, typically have fixed size splitters.

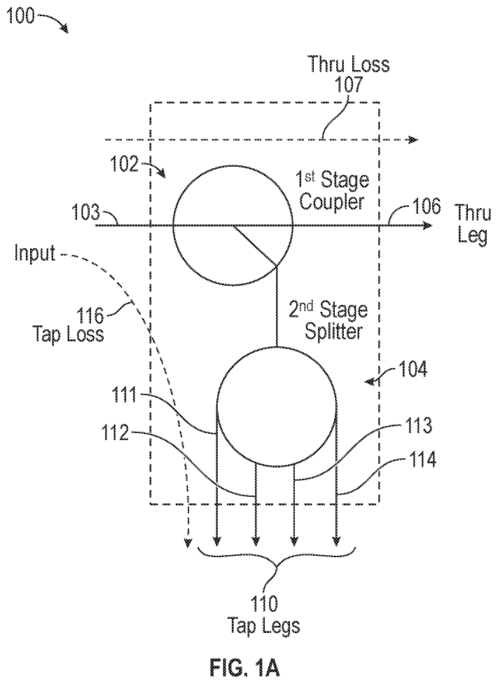

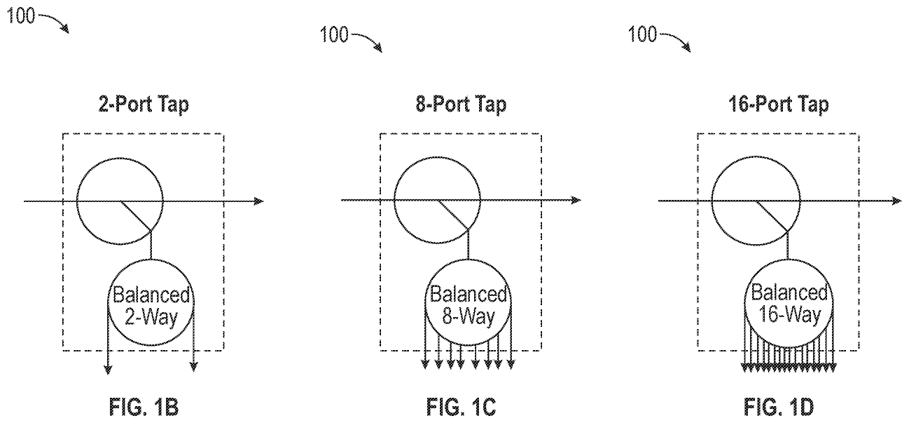

The distributed optical tap solution may take the fiber efficiency concept a step further, because it may require much less fiber and fewer fusion splices than either conventional method described above. It may also enable a user to control the ‘size’ (for example, number tap ports or legs) of the splitter included with the tap based on the number of legs needed and control the signal loss based on how much signal is received at a given location, and therefore may be much less wasteful than the other approaches. The optical tap solution may simplify the application by pre-engineering combinations of a first stage coupler and a second stage splitter into a structured system of pre-integrated modular tap devices (as may be depicted and described below with respect to FIGS. 1A-1D, for example). A tap being modular may refer to the fact that multiples of any tap type can be installed within any fiber enclosure. This contrasts with other solutions which integrate distributed splitters into a fiber enclosure, which may not allow for as much flexibility to add ports or control signal levels. For example, if a user needs to add additional ports to a tap for new customers, they could replace a 2-port tap module with a 4-port tap module. As another example, if a technician needs more or less signal at a given location, they can simply replace the tap module with a different incremental value module. In addition to the significant cost savings of minimizing fiber materials and fusion splice labor, this solution may not require a centralized cabinet for housing banks of splitters which may be expensive and challenging to get permission from municipals to build in the Right-of-Way. The distributed optical tap solution may also improve damage restoration time, because customer service may be dependent on fewer fibers and may be respliced quicker in the event of a damaged cable.

In some embodiments, an optical tap as described above may be a single tap device in a network including multiple tap devices. FIGS. 1A-1D described below, for example, may depict different configurations for an optical tap that may be deployed in a network. The optical tap may be a combination of a first stage coupler and a second stage splitter. The first stage coupler may be an asymmetrical splitter, which may serve as a signal control valve that may be used to distribute the input signal at the optical tap (for example, received from an upstream portion of the network) to one or more customer devices and pass through the remainder of the input signal to a downstream portion of the network (which may include one or more additional tap devices connected to one or more additional customer devices in the network). To this end, the first stage coupler may also ensure that the throughput (signal that is passed through the tap and downstream the network, which may be shown as “Thru loss” in FIGS. 1A-1D) is maximized while the drop off signal to the customer devices (which may be shown as “Tap loss” in FIGS. 1A-1D) is minimized. This may allow for the management of signal levels in a more controlled manner to minimize the amount of ‘lost’ signal provided to customer devices through the tap legs. This is because the splitter loss characteristics may be engineered in varying incremental values as opposed to one common fixed loss characteristic applied universally. As one non-limiting example, an optical tap may pass 90% of a received signal downstream, and may drop off 10% of the received signal to one or more customer devices connected to the tap. However, this is merely an example, any other percentages may similarly be applicable.

The second stage splitter may be a balanced splitter that may receive signal from the first stage coupler and may provide the signal to one or more customer devices attached to the tap. The number of “legs” (or “ports”) included in the second stage splitter may depend on the number of customer devices being served by the particular tap. For example, if the tap is serving four customers, then a second stage splitter with four legs may be provided in that particular tap device. Examples of different second stage splitters including different numbers of legs may be depicted in FIGS. 1A-1D described below. The modularity of the tap may come into play within the fiber enclosure or fiber terminal in which it is installed. That is, multiples of taps may be deployed as needed within any given fiber terminal and may be replaced as needed to adjust port quantities and/or signal levels. For example, if a given location services 10 customers, the operator may deploy an 8-port and 2-port tap within a service terminal. In the future if an additional customer needs to be fed from that location, the 2-port tap module may be replaced with a 4-port tap module. Another example is if the signal level needs to be adjusted due to changing field conditions, the tap module may be replaced with a different incremental value for up/down signal level adjustments.

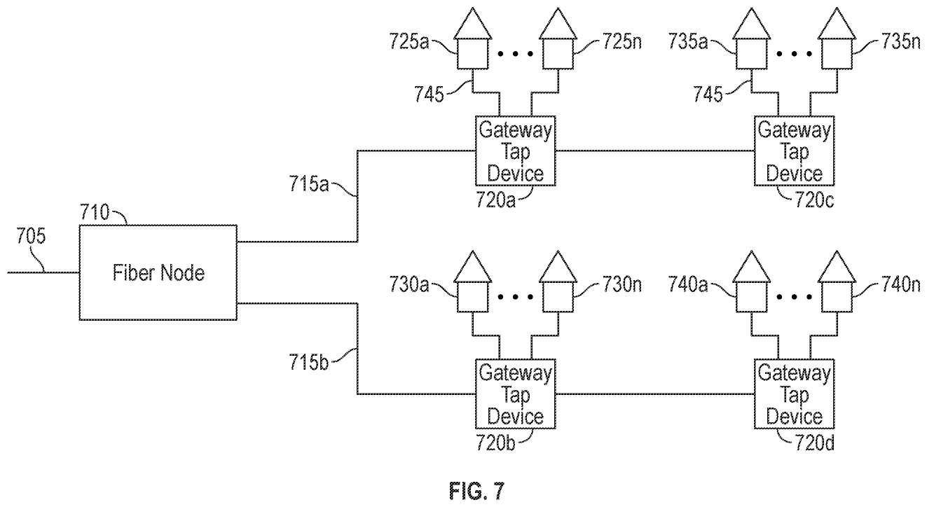

Turning to the figures, FIGS. 1A-1D illustrate example embodiments of the optical tap 100 device. Beginning with FIG. 1A, a first example embodiment of an optical tap 100 may be a single tap device in a network including multiple tap devices (systems including multiple tap devices may be illustrated in FIG. 7, for example). The optical tap 100 may include a combination of a first stage coupler 102 and a second stage splitter 104. The first stage coupler 102 may be an asymmetrical splitter, which may serve as a signal control valve that may be used to distribute the input signal 103 at the optical tap 100 (for example, received from an upstream portion of the network) to one or more customer devices and pass through the remaining signal to a downstream portion of the network (which may include one or more additional tap devices connected to one or more additional customer devices in the network). For example, the optical tap 100 may pass a portion of the signal through a downstream portion of the network through a “Thru leg” 106 of the optical tap, and may pass a portion of the signal to the customer devices through the one or more tap legs 110 described below. To this end, the first stage coupler 102 may also ensure that the throughput (signal that is passed through the tap and downstream the network, which may be shown as “Thru loss” 107 in FIGS. 1A-1D) is maximized while the drop off signal to the customer devices (which may be shown as “Tap loss” 116 in FIGS. 1A-1D) is minimized. As one non-limiting example, an optical tap 100 may pass 90% of an input signal 103 downstream through the Thru leg 106, and may drop off 10% of the input signal 103 to one or more customer devices connected to the tap through the one or more tap legs 110. However, this is merely an example, any other percentages may similarly be applicable. The second stage splitter 104 may be a balanced splitter that may receive signal from the first stage coupler and provides the signal to one or more customer devices attached to the optical tap 100. The number of tap legs 110 included in the second stage splitter 104 may depend on the number of customer devices being served by the particular tap 100. For example, if the tap 100 is serving four customer devices (as depicted in FIG. 1A), then a second stage splitter 104 with four legs 110 (for example, a first leg 111, second leg 112, third leg 113, and/or fourth leg 114) may be provided in that particular tap device. Examples of different second stage splitters including different numbers of legs may be depicted in FIGS. 1A-1D described below. “Tap Loss” 116 may be the actual optical insertion loss characteristic of the signal level difference between the signal level entering the first stage coupler 102 input 103 and the signal level exiting the second stage splitter 104 on the Tap Legs 110 and may be used for engineering calculations. “Tap Value” may be closely related to tap loss 116. The value may be a simplified rounded numeric indicator of tap loss 116 and may be used for simplifying network management and part numbering purposes.

FIGS. 1B-1D depict additional example configurations of the optical tap 100. The different embodiments shown in FIGS. 1B-1D may include different second stage coupler configurations including different numbers of legs to customer devices. For example, FIG. 1B may depict a second stage splitter with two legs, FIG. 1C may depict a second stage splitter with eight legs, and FIG. 1D may depict a second stage splitter with 16 legs.

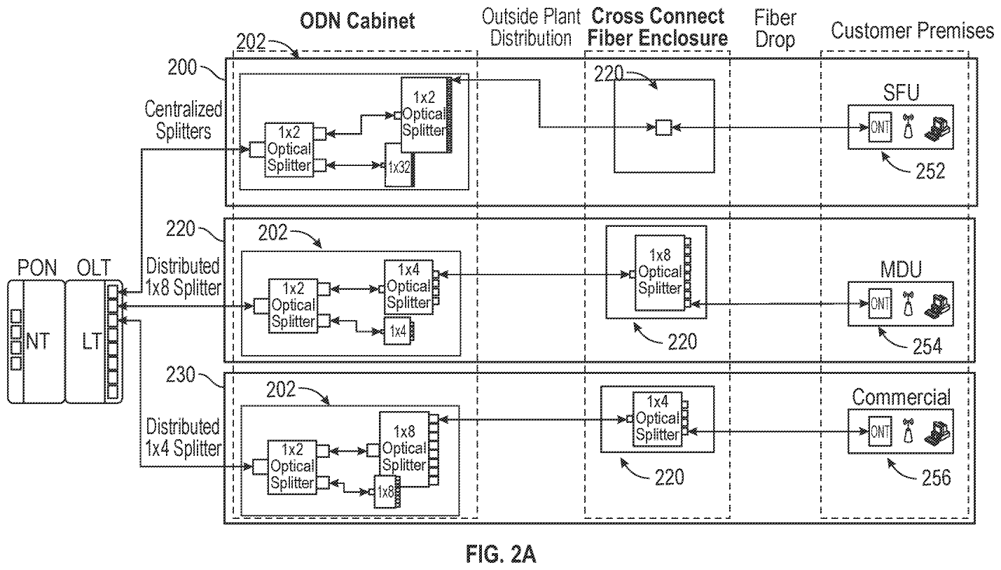

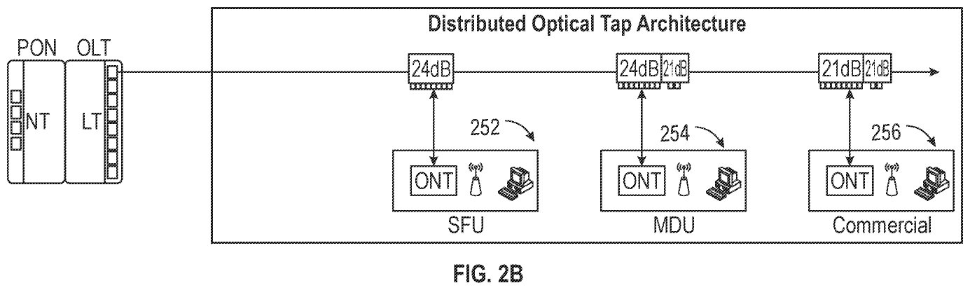

FIGS. 2A-2B depict an example comparison of conventional optical tap configurations (for example, shown in FIG. 2A) in a network with the improved optical tap configuration in a network as described herein (for example, shown in FIG. 2B). FIG. 2A depicts three example common conventional architecture types: one example of a centralized splitter 200 architecture and two examples of a distributed splitter architecture (for example, distributed splitter 220 and distributed splitter 230). The centralized splitter 200 architecture may assume a centralized bank of splitters are located in an Optical Distribution Network (ODN) cabinet 202 based on a pre-determined static split ratio (1:64, for example). Each customer may then get their own dedicated fiber spliced in parallel from the cabinet 202 to customer premise. The distributed splitter architecture may also be based on a pre-determined static split ratio (1:64, for example), but a portion of that split ratio may be distributed to a fiber enclosure (for example, cross connect 220) closer to the customer premise 208. For example in the example distributed splitter 220, an operator may distribute a 1×4 splitter near the customer and may assume the first 1×16 of the total 1:64 split ratio is in the cabinet. An alternative example may be presented as distributed splitter 230, in which an operator may distribute a 1x8 splitter near the customer and may assume the first 1×8 of the total 1:64 split ratio is in the cabinet. The advantage of distributing splitters (for example, distributed splitter 220 and/or distributed splitter 230, as well as any other distributed splitter configuration) over centralized splitters (for example, centralized splitter 200) may include the reduction in fiber material and fusion splice labor required to build the network. However, it can be wasteful because with any static split ratio there rarely may be exactly 64 customers to feed, so those additional ports become stranded. Furthermore, in a static split ratio architecture the more of the split ratio that is distributed, the more ports may be stranded, because one common distributed splitter size may be needed to maintain consistent signal loss to each customer.

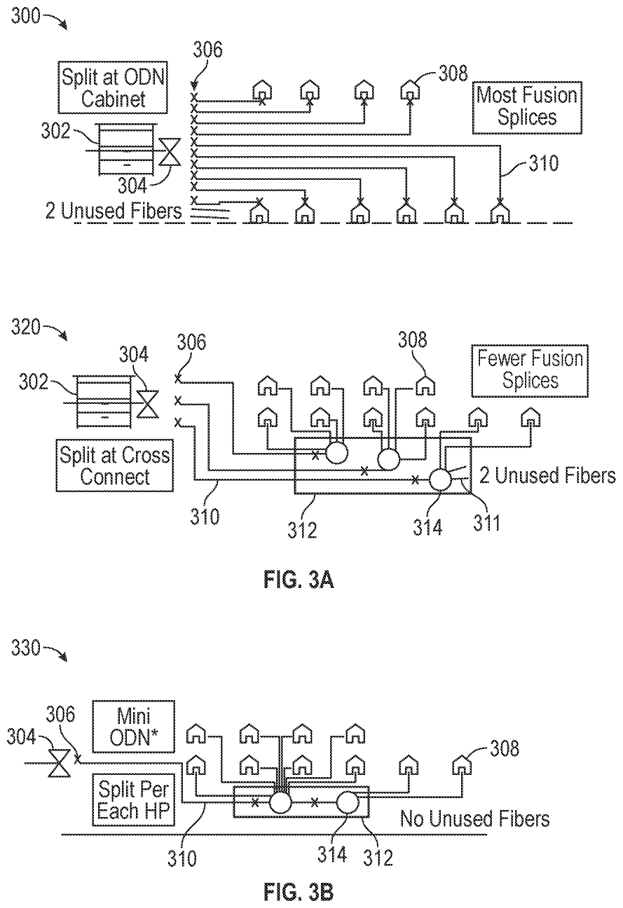

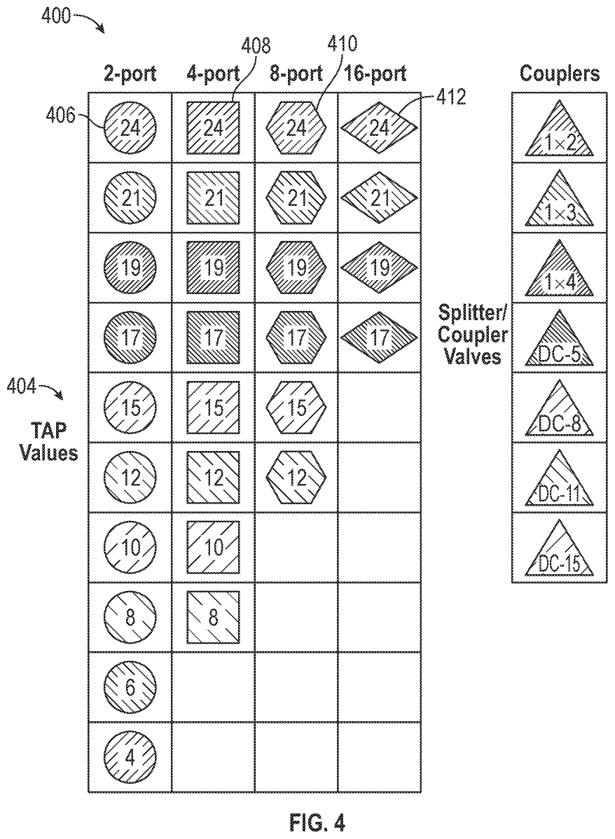

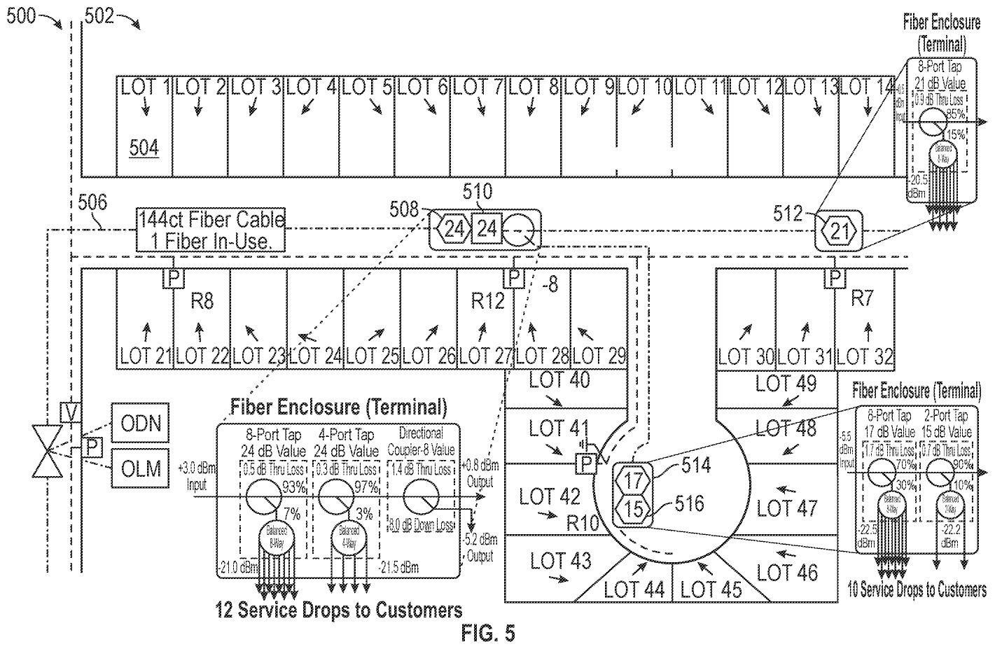

FIG. 2B may depict a block diagram example of network diversity that may be possible using the optical tap described herein (for example, servicing a SFU (Single Family Units) 252, MDU (Multi-Dwelling Units) 254 and commercial properties 256 with the same fiber. Conventional methods today make it difficult to mix customer types on a common fiber or OLT port. Conventional methods today (for example, as depicted in FIG. 2A and FIG. 3A), may be optimized for different customer densities. A high-rise MDU for example is very dense, more customers can be fed from one common cross connect location, therefore the larger 1×8 distributed splitter size is most cost effective, because the application supports high counts of service drops from a common location. In contrast, a low-density SFU the customers are more spread out and fewer can be fed from a common cross connect location, therefore a distributed splitter may be wasteful because not all ports could be used at each cross connect. Distributed optical taps (FIG. 4-5, for example) allow the distributed splitter size to vary based on the number of customers fed from a common location, therefore is more efficient.

FIGS. 3A-3B may provide alternative illustrations of the conventional architectures depicted in FIG. 2A (for example, which may be depicted in FIG. 3A) and the optical tap configuration described herein and shown in FIG. 2B (for example, which may be depicted in FIG. 3B. FIG. 3A may depict the three example common conventional architecture types. For example, FIG. 3A may depict an example centralized splitter 300 architecture, a first example distributed splitter 320 architecture and a second example distributed splitter architecture 330. The illustrations provided in FIG. 3A may provide examples of the difference in fusion splices between the conventional approaches. With respect to the example centralized splitter 300 architecture, individual fibers 310 from the ODN cabinet 302 may be provided to customer premises 308 in parallel. With respect to the first distributed splitter 320 architecture, a central ODN cabinet 302 may also be used, but a portion of the pre-determined split ratio may be distributed near the customer premise with fibers being provided to customer premises 308 in parallel. The disadvantage of this type of solution is the distributed splitter size may be fixed and may not allow for varying customer counts at a given location, so the business case for a distributed splitter architecture may involve savings from fiber splicing reduction versus stranded capacity. Finally, FIG. 3B may depict a third optical tap configuration 340, which may be representative of the optical tap configuration described herein. As depicted in FIG. 3B, the optical tap configuration 330 may not use a central ODN cabinet 302 and may use one fiber connecting multiple tap devices in series. The number of ports of each tap may be different, therefore minimizing unused fibers, furthermore it requires the least amount of fiber material and fusion splice labor.

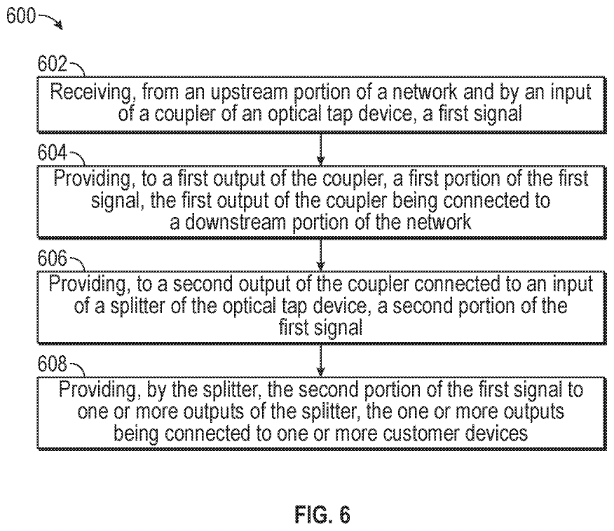

FIG. 4 depicts a table 400 including example tap value combinations that may be used in the optical tap device described herein. “Tap Value” 404 may be closely related to tap loss 116. The value may be a simplified rounded numeric indicator of tap loss 116 and may be used for simplifying network management and part numbering purposes. Each symbol shown within the table 400 may represent a combination of a first stage coupler and a second stage splitter in a given optical tap configuration. For example, the example symbols depicted in table 400 may include a first symbol 406 (for example, a circle), a second symbol 408 (for example, a square), a third symbol 410 (for example, a hexagon), and/or a fourth symbol 412 (for example, a diamond). The symbols used in the table 400 may simply be exemplary, and any other symbols may likewise be used as well. Additionally, any other combinations of tap values other than those shown in the table 400 may also be used. This table 400 may serve as a key for some of the system figures depicted herein (for example, FIGS. 5-6).

Continuing with FIG. 4, the x-axis 402 of the table 400 may indicate the size of the second stage splitter in the optical tap. For example, the table 400 may depict a 2-port, 4-port, 8-port, and/or 16-port second stage splitter. These number of ports included in each of these options may refer to the number of output legs being provided from the optical tap to customer devices (for example, as shown in FIGS. 1A-1D). The y-axis 404 of the table 400 may represent the tap value 404, which may represents the amount of signal loss from input to tap leg outputs.(for example, signal that is provided to customer devices rather than being transmitted downstream to other optical tap devices). When configuring a particular optical tap on the network, the operator may pre-determine a minimum tap leg output level parameter to apply to all tap locations, and tap values may be selected based on the input signal level at a given location to meet or exceed the minimum tap leg output level. Additionally, the operator may select the tap size or combination of varying tap sizes to support the number of customers planned to be serviced from that location. For example, if a location will service eight customers and the pre-determined minimum tap leg output level at all locations must be a minimum of −24 dBm, and the signal level entering the location is −2 dBm, then the operator may select an 8-Port 21 value tap which may result in −23 dBm on all 8 tap legs at that location. This may pass −3 dBm ‘Thru’ the tap to the next location (for example, to another tap). Alternatively, if that same location is planned to service 12 customers instead of eight, then a combination of an 8-Port and a 4-Port tap may be installed within the same enclosure. In this case both taps could be a 21 value, the first tap may result in −23 dBm on tap legs and the second tap may result in −24 dBm because it may receive a lower signal strength than the first. If needed, the value of the second tap could be reduced to a 19 value to increase the tap leg level by 2 dB.

FIG. 5 is an example of a system map 500 of a standard distributed optical tap application. For example, FIG. 5 may depict a real-world implementation of the optical taps described herein in an example neighborhood 502 including one or more customer premises 504 (which may be labeled as “lots”). A network 506 servicing the neighborhood 502 may include one or more optical taps depicting using the symbols outlined in FIG. 3. For example, a first optical tap 508 and second optical tap 510 may include a total of 12 legs between the two taps, and thus may service up to 12 customer premises 504. Both optical tap 508 and optical tap 510 may be located within the same fiber enclosure and spliced together internally. The customer premises that are serviced by the optical tap 508 and the optical tap 510 may be indicated by the direction in which the arrows are pointing in the different customer premises 504. For example, lots 5-10 and 25-29 may be depicted as pointing towards the first optical tap 508 and the second optical tap 510. Fiber drop cables may be connected to tap legs and run on-property to service Optical Network Terminals (ONT) on those customer premises. The same may also apply to the third optical tap 512, as well as the fourth optical tap 514 and the fifth optical tap 516. Connections between fiber enclosures may be made with multi-fiber service cables, in which only one allocated fiber may be fusion spliced to optical taps on each end. For example, the connection from optical tap 510 to optical tap 512 may be made with a 144 count fiber cable run between the two fiber enclosures and fusion spliced to the optical tap modules within the fiber enclosures on either end. As described above, if any lots were to be added and/or removed from the neighborhood 502, then any of the optical taps depicted in the figure may be swapped for taps with different numbers of ports. Additionally, taps may be added and/or removed as necessary. This is one example of the modularity that such taps provide. Any of the taps depicted in FIG. 5 may be the same as, or similar to, any of the taps described with respect to FIGS. 1A-1D, as well as any other taps described herein.

FIG. 6 is an example method 600. At block 602 of the method 600 in FIG. 6, the method 600 may include receiving, from an upstream portion of a network and by an input of a coupler of an optical tap device, a first signal. At block 604 of the method 600 in FIG. 6, the method 600 may include providing, to a first output of the coupler, a first portion of the first signal, the first output of the coupler being connected to a downstream portion of the network. At block 606 of the method 600 in FIG. 6, the method 600 may include providing, to a second output of the coupler connected to an input of a splitter of the optical tap device, a second portion of the first signal. At block 608 of the method 600 in FIG. 6, the method 600 may include providing, by the splitter, the second portion of the first signal to one or more outputs of the splitter, the one or more outputs being connected to one or more customer devices. The optical tap may be a combination of a first stage coupler and a second stage splitter. The first stage coupler may be an asymmetrical splitter, which may serve as a signal control valve that may be used to distribute the input signal at the optical tap (for example, received from an upstream portion of the network) to one or more customer devices and pass through the remainder of the input signal to a downstream portion of the network (which may include one or more additional tap devices connected to one or more additional customer devices in the network). To this end, the first stage coupler may also ensure that the throughput (which may be the first portion of the first signal) is maximized while the drop off signal to the customer devices (which may be the second portion of the first signal) is minimized. This may allow for the management of signal levels in a more controlled manner to minimize the amount of ‘lost’ signal provided to customer devices through the tap legs. This is because the splitter loss characteristics may be engineered in varying incremental values as opposed to one common fixed loss characteristic applied universally. As one non-limiting example, an optical tap may pass 90% of a received signal downstream, and may drop off 10% of the received signal to one or more customer devices connected to the tap. However, this is merely an example, any other percentages may similarly be applicable.

The second stage splitter may be a balanced splitter that may receive signal from the first stage coupler (for example, the second portion of the first signal) and may provide the signal to one or more customer devices attached to the tap. The number of “legs” (or “ports”) included in the second stage splitter may depend on the number of customer devices being served by the particular tap. For example, if the tap is serving four customers, then a second stage splitter with four legs may be provided in that particular tap device. Examples of different second stage splitters including different numbers of legs may be depicted above in FIGS. 1A-1D. The modularity of the tap may come into play within the fiber enclosure or fiber terminal in which it is installed. That is, multiples of taps may be deployed as needed within any given fiber terminal and may be replaced as needed to adjust port quantities and/or signal levels. For example, if a given location services 10 customers, the operator may deploy an 8-port and 2-port tap within a service terminal. In the future if an additional customer needs to be fed from that location, the 2-port tap module may be replaced with a 4-port tap module. Another example is if the signal level needs to be adjusted due to changing field conditions, the tap module may be replaced with a different incremental value for up/down signal level adjustments.

The operations described and depicted in the illustrative process flow of FIG. 6 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIG. 6 may be performed.

Referring now to FIG. 7, a system 700 for providing broadband communication using optical fibers is provided in accordance with one or more example embodiments. The system 700 may include an optical fiber distribution node 710, referred to hereinafter as a fiber node 710, which may be configured to receive a downstream signal (e.g., from a source component) via an input optical fiber 705. In addition, the fiber node 710 may be coupled to one or more gateway tap devices 720a-d (which may be the same as any of the tap devices described herein) via one or more output optical fibers 715a-b. It will be appreciated that any number of fiber nodes 710 may be in communication with any number of gateway tap devices 720a-d via any number of output optical fibers 715a-b. Furthermore, the respective gateway tap devices 720a-d may be configured to provide broadband service to any number of customer premises 725a-n, 730a-n, 735a-n, and 740a-n.

According to one or more embodiments, the fiber node 710 may be configured to transmit the received downstream signal to one or more output optical fibers 715a-b. For instance, the fiber node 710 may split the received downstream signal onto the output optical fibers 715a-b. As such, the downstream signal may be transmitted to gateway tap devices 720a and 720c via output optical fiber 715a. Similarly, the downstream signal may be transmitted to gateway tap devices 720b and 720d via output optical fiber 715b. In other words, the downstream signal may be delivered by using optical fibers all the way to the gateway tap devices 720a-d.

Additionally, the gateway tap devices 720a-d may be configured to convert the received downstream signal and convert the downstream signal in to a radio frequency downstream signal. The gateway tap device 720a-b may facilitate the operations of both a gateway and/or a tap/terminator. Furthermore, the gateway tap devices 720a-d may provide the radio frequency downstream signals to their respective customer premises (e.g., customer premises 725a-n, 730a-n, 735a-n, and 740a-n). To this end, the radio frequency downstream signal may be provided to the customer premises using one or more cable lines.

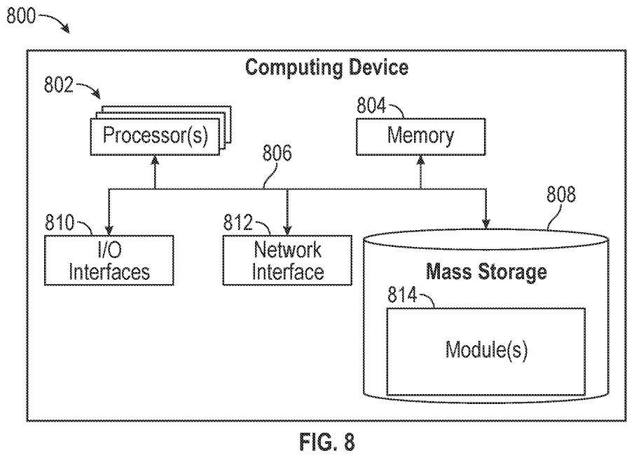

FIG. 8 illustrates an example computing device 800, in accordance with one or more embodiments of this disclosure. The computing 800 device may be representative of any number of elements described herein. The computing device 800 may include at least one processor 802 that executes instructions that are stored in one or more memory devices (referred to as memory 804). The instructions can be, for instance, instructions for implementing functionality described as being carried out by one or more modules and systems disclosed above or instructions for implementing one or more of the methods disclosed above. The processor(s) 802 can be embodied in, for example, a CPU, multiple CPUs, a GPU, multiple GPUs, a TPU, multiple TPUs, a multi-core processor, a combination thereof, and the like. In some embodiments, the processor(s) 802 can be arranged in a single processing device. In other embodiments, the processor(s) 802 can be distributed across two or more processing devices (e.g., multiple CPUs; multiple GPUs; a combination thereof; or the like). A processor can be implemented as a combination of processing circuitry or computing processing units (such as CPUs, GPUs, or a combination of both). Therefore, for the sake of illustration, a processor can refer to a single-core processor; a single processor with software multithread execution capability; a multi-core processor; a multi-core processor with software multithread execution capability; a multi-core processor with hardware multithread technology; a parallel processing (or computing) platform; and parallel computing platforms with distributed shared memory. Additionally, or as another example, a processor can refer to an integrated circuit (IC), an ASIC, a digital signal processor (DSP), an FPGA, a PLC, a complex programmable logic device (CPLD), a discrete gate or transistor logic, discrete hardware components, or any combination thereof designed or otherwise configured (e.g., manufactured) to perform the functions described herein.

The processor(s) 802 can access the memory 804 by means of a communication architecture 806 (e.g., a system bus). The communication architecture 806 may be suitable for the particular arrangement (localized or distributed) and type of the processor(s) 802. In some embodiments, the communication architecture 806 can include one or many bus architectures, such as a memory bus or a memory controller; a peripheral bus; an accelerated graphics port; a processor or local bus; a combination thereof, or the like. As an illustration, such architectures can include an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, a Peripheral Component Interconnect (PCI) bus, a PCI-Express bus, a Personal Computer Memory Card International Association (PCMCIA) bus, a Universal Serial Bus (USB), and/or the like.

Memory components or memory devices disclosed herein can be embodied in either volatile memory or non-volatile memory or can include both volatile and non-volatile memory. In addition, the memory components or memory devices can be removable or non-removable, and/or internal or external to a computing device or component. Examples of various types of non-transitory storage media can include hard-disc drives, zip drives, CD-ROMs, digital versatile disks (DVDs) or other optical storage, magnetic cassettes, magnetic tape, magnetic disk storage or other magnetic storage devices, flash memory cards or other types of memory cards, cartridges, or any other non-transitory media suitable to retain the desired information and which can be accessed by a computing device.

As an illustration, non-volatile memory can include read-only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The disclosed memory devices or memories of the operational or computational environments described herein are intended to include one or more of these and/or any other suitable types of memory. In addition to storing executable instructions, the memory 804 also can retain data.

Each computing device 800 also can include mass storage 808 that is accessible by the processor(s) 802 by means of the communication architecture 806. The mass storage 808 can include machine-accessible instructions (e.g., computer-readable instructions and/or computer-executable instructions). In some embodiments, the machine-accessible instructions may be encoded in the mass storage 808 and can be arranged in components that can be built (e.g., linked and compiled) and retained in computer-executable form in the mass storage 808 or in one or more other machine-accessible non-transitory storage media included in the computing device 800. Such components can embody, or can constitute, one or many of the various modules disclosed herein. Such modules are illustrated as modules 814. In some instances, the modules may also be included within the memory 804 as well.

Execution of the modules 814, individually or in combination, by at least one of the processor(s) 802, can cause the computing device 800 to perform any of the operations described herein (for example, the operations described with respect to FIG. 6, as well as any other operations).

Each computing device 800 also can include one or more input/output interface devices 810 (referred to as I/O interface 810) that can permit or otherwise facilitate external devices to communicate with the computing device 800. For instance, the I/O interface 810 may be used to receive and send data and/or instructions from and to an external computing device.

The computing device 800 also includes one or more network interface devices 812 (referred to as network interface(s) 812) that can permit or otherwise facilitate functionally coupling the computing device 800 with one or more external devices. Functionally coupling the computing device 800 to an external device can include establishing a wireline connection or a wireless connection between the computing device 800 and the external device. The network interface devices 812 can include one or many antennas and a communication processing device that can permit wireless communication between the computing device 800 and another external device. For example, between a vehicle and a smart infrastructure system, between two smart infrastructure systems, etc. Such a communication processing device can process data according to defined protocols of one or several radio technologies. The radio technologies can include, for example, 3G, Long Term Evolution (LTE), LTE-Advanced, 5G, IEEE 802.11, IEEE 802.16, Bluetooth, ZigBee, near-field communication (NFC), and the like. The communication processing device can also process data according to other protocols as well, such as vehicle-to-infrastructure (V2I) communications, vehicle-to-vehicle (V2V) communications, and the like. The network interface(s) 512 may also be used to facilitate peer-to-peer ad-hoc network connections as described herein.

As used in this application, the terms “environment,” “system,” “unit,” “module,” “architecture,” “interface,” “component,” and the like refer to a computer-related entity or an entity related to an operational apparatus with one or more defined functionalities. The terms “environment,” “system,” “module,” “component,” “architecture,” “interface,” and “unit,” can be utilized interchangeably and can be generically referred to functional elements. Such entities may be either hardware, a combination of hardware and software, software, or software in execution. As an example, a module can be embodied in a process running on a processor, a processor, an object, an executable portion of software, a thread of execution, a program, and/or a computing device. As another example, both a software application executing on a computing device and the computing device can embody a module. As yet another example, one or more modules may reside within a process and/or thread of execution. A module may be localized on one computing device or distributed between two or more computing devices. As is disclosed herein, a module can execute from various computer-readable non-transitory storage media having various data structures stored thereon. Modules can communicate via local and/or remote processes in accordance, for example, with a signal (either analogic or digital) having one or more data packets (e.g., data from one component interacting with another component in a local system, distributed system, and/or across a network such as a wide area network with other systems via the signal).

As yet another example, a module can be embodied in or can include an apparatus with a defined functionality provided by mechanical parts operated by electric or electronic circuitry that is controlled by a software application or firmware application executed by a processor. Such a processor can be internal or external to the apparatus and can execute at least part of the software or firmware application. Still, in another example, a module can be embodied in or can include an apparatus that provides defined functionality through electronic components without mechanical parts. The electronic components can include a processor to execute software or firmware that permits or otherwise facilitates, at least in part, the functionality of the electronic components.

In some embodiments, modules can communicate via local and/or remote processes in accordance, for example, with a signal (either analog or digital) having one or more data packets (e.g., data from one component interacting with another component in a local system, distributed system, and/or across a network such as a wide area network with other systems via the signal). In addition, or in other embodiments, modules can communicate or otherwise be coupled via thermal, mechanical, electrical, and/or electromechanical coupling mechanisms (such as conduits, connectors, combinations thereof, or the like). An interface can include input/output (I/O) components as well as associated processors, applications, and/or other programming components.

Further, in the present specification and annexed drawings, terms such as “store,” “storage,” “data store,” “data storage,” “memory,” “repository,” and substantially any other information storage component relevant to the operation and functionality of a component of the disclosure, refer to memory components, entities embodied in one or several memory devices, or components forming a memory device. It is noted that the memory components or memory devices described herein embody or include non-transitory computer storage media that can be readable or otherwise accessible by a computing device. Such media can be implemented in any methods or technology for storage of information, such as machine-accessible instructions (e.g., computer-readable instructions), information structures, program modules, or other information objects.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems, devices, techniques, and computer program products that, individually and in combination, permit the automated provision of an update for a vehicle profile package. It is, of course, not possible to describe every conceivable combination of components and/or methods for purposes of describing the various elements of the disclosure, but it can be recognized that many further combinations and permutations of the disclosed elements are possible. Accordingly, it may be apparent that various modifications can be made to the disclosure without departing from the scope or spirit thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

That which is claimed is:

1. An optical tap device comprising:
a coupler comprising an input configured to be connected to an upstream portion of a network and a first output configured to be connected to a downstream portion of the network; and
a splitter with an input configured to be connected to a second output of the coupler and one or more outputs configured to be connected to one or more customer devices, wherein the coupler and splitter are modular components in the optical tap device and are configured to be replaced with a second coupler and a second splitter based on a number of customer devices associated with the optical tap device.

2. The optical tap device of claim 1, wherein the coupler is an asymmetrical splitter and the splitter is a balanced splitter.

3. The optical tap device of claim 1, wherein the optical tap device is located proximate to the one or more customer devices.

4. The optical tap device of claim 1, wherein the coupler and splitter are included within a physical package.

5. The optical tap device of claim 1, wherein the optical tap device is configured to be coupled to a Passive Optical Networking (PON) network.

6. A system comprising:
an optical tap device comprising:
a coupler comprising an input connected to an upstream portion of a network and a first output connected to a downstream portion of the network; and
a splitter with an input connected to a second output of the coupler and one or more outputs connected to one or more customer devices, wherein the coupler and splitter are modular components in the optical tap device and are configured to be replaced with a second coupler and a second splitter based on a number of customer devices associated with the optical tap device.

7. The system of claim 6, wherein the coupler is an asymmetrical splitter and the splitter is a balanced splitter.

8. The system of claim 6, wherein the coupler and splitter are included within a physical package.

9. The system of claim 8, wherein a second optical tap device is included within the physical package with the optical tap device.

10. The system of claim 9, wherein the second optical tap device includes a splitter with a different number of outputs than the splitter of the optical tap device.

11. The system of claim 6, wherein the optical tap device is located proximate to the one or more customer devices.

12. The system of claim 6, wherein the downstream portion of the network comprises a second optical tap device connected in series with the optical tap device.

13. The system of claim 6, wherein the network is a Passive Optical Networking (PON) network and the upstream portion of the network comprises an optical line terminal (OLT).

14. A method comprising
receiving, from an upstream portion of a network and by an input of a coupler of an optical tap device, a first signal;
providing, to a first output of the coupler, a first portion of the first signal, the first output of the coupler being connected to a downstream portion of the network;
providing, to a second output of the coupler connected to an input of a splitter of the optical tap device, a second portion of the first signal; and
providing, by the splitter, the second portion of the first signal to one or more outputs of the splitter, the one or more outputs being connected to one or more customer devices, wherein the coupler and splitter are modular components in the optical tap device and are configured to be replaced with a second coupler and a second splitter based on a number of customer devices associated with the optical tap device.

15. The method of claim 14, wherein the coupler is an asymmetrical splitter and the splitter is a balanced splitter.

16. The method of claim 14, wherein the coupler and splitter are included within the same physical package.

17. The method of claim 16, wherein a second optical tap device is included within the physical package with the optical tap device.

18. The method of claim 17, wherein the second optical tap device includes a splitter with a different number of outputs than the splitter of the first optical tap device.

19. The method of claim 14, wherein the downstream portion of the network comprises a second optical tap device connected in series with the optical tap device.

20. The method of claim 14, wherein the network is a Passive Optical Networking (PON) network and the upstream portion of the network comprises an optical line terminal (OLT).
